(19) United States
(12) Patent Application Publication
(10) Pub. No.: US 2025/0237109 A1
(43) Pub. Date: Jul. 24, 2025

(54) ELECTRIC CURTAIN

(71) Applicant: Guangdong Chuangming Sun-Shade Technology Co., Ltd., Guangzhou (CN)

(72) Inventors: Caifa JIANG, Guangzhou (CN); Wen WEI, Guangzhou (CN); Junlong WEI, Guangzhou (CN)

(21) Appl. No.: 18/741,259

(22) Filed: Jun. 12, 2024

(30) Foreign Application Priority Data
Jan. 18, 2024 (CN) 202420125908.4

(51) Int. Cl. E06B 9/72; H02J 7/00

(52) U.S. Cl. CPC E06B 9/72; H02J 7/0042

(57) ABSTRACT

The disclosure provides an electric curtain. The electric curtain includes a guide rail, a telescopic rod, and a power supply, wherein a telescopic end of the telescopic rod is provided with a connecting butt-joint piece, the connecting butt-joint piece is configured to be detachably connected to the electric curtain, the connecting butt-joint piece is provided with a power output end, the power output end input power to the electric curtain, the power output end is electrically connected to the power supply, the connecting butt-joint piece is provided with a support piece, and the support piece supports the telescopic rod on the electric curtain. Compared with the existing wireless charging manner of charging the electric curtain, the present application has relatively high charging efficiency, a relatively short full charging time, and does not bring inconvenience to a user, improves the convenience of using the electric curtain.

### CROSS-REFERENCE TO RELATED APPLICATIONS

This application claims priority to Chinese Patent Application No. 202420125908.4, filed on Jan. 18, 2024, which is incorporated herein by reference in its entirety.

### TECHNICAL FIELD

The present application belongs to the technical field of curtains, and particularly relates to an electric curtain.

### BACKGROUND

An electric curtain is a manner of controlling the curtain wirelessly through a motor drive. The electric curtain has the following main functions of thermal insulation, ultraviolet ray blocking, and light adjustment, and also has the characteristics of privacy protection, light utilization, sound insulation, noise prevention, and the like. In terms of classification, the electric curtains may be classified into built-in and external types. The structure of the electric curtain includes a motor, a controller, a pulley, a belt, and other parts. The motor is the core component of the electric curtain, and is responsible for driving the movement of the curtain.

Compared with a manual curtain, the electric curtain has the following advantages: (1) modern home and office environments have increasing demands for decoration styles, and the electric curtain may be selected according to the interior decoration style to be coordinated with the environment, thereby increasing the indoor aesthetics. (2) In an office, if the light and privacy need to be adjusted, the manual curtain needs to be pulled with time and energy, especially with the increasing prevalence of large-area, heavy, or high-positioned curtains, if the curtain is manually pulled, a large amount of time and effort need to be spent. However, the electric curtain may be easily controlled by a remote controller or a mobile APP, thereby saving time and energy, and improving efficiency.

A power supply as the core of driving the operation of the electric curtain, the current mainstream power supply manners for the electric curtain mainly include battery power supply and power adapter power supply. (1) The power adapter power supply is the most common manner of supplying power to a track of the electric curtain, suitable for most home and office environments. A power adapter may provide the appropriate power voltage and current according to the requirements for the track to ensure stable power supply. However, the use of the power adapter requires a power interface, and support from a home appliance socket. (2) The most common manner of supplying power to the track of the electric curtain is through the battery, and the battery power supply is a portable and flexible power supply manner, suitable for scenarios where power adapter power supply cannot be used or is inconvenient to use. The battery power supply has the advantage that the operation is simple and convenient, and may be used anytime and anywhere, but the battery needs to be continuously replaced, and charging and charging are inconvenient.

In the related art, a curtain drive charging apparatus and system are disclosed, a charging sending assembly is matched with a charging receiving piece to charge a rechargeable lithium battery of a driving piece, using both wired and wireless charging manners.

When the charging sending assembly and the charging receiving piece use the wired charging manner, the charging receiving piece in this embodiment is a socket, and the charging sending assembly is a plug. The specific wired charging process is as follows: the driving piece is controlled to drive a curtain moving assembly to rotate, the curtain moving assembly drives a curtain body to move to be rolled up, the curtain body drives a plug on a lower beam assembly to move towards the socket, so that the plug is directly inserted into the socket, and the plug is connected to an external mains through a wire. In this way, the rechargeable lithium battery of the driving piece is charged through the matching of the plug and the socket.

When the charging sending assembly and the charging receiving piece use the wireless charging manner, the charging receiving piece is a wireless charging receiving end, and the charging sending assembly is a wireless charging transmitting end. The charging receiving piece has a first magnetic adsorption part. The charging sending assembly has a second magnetic adsorption part. The first magnetic adsorption part and the second magnetic adsorption part in this embodiment are magnets. The wireless charging receiving end and the wireless charging transmitting end may use a wireless charging receiving end and a wireless charging transmitting end for existing wireless charging, and magnets are respectively integrated in the wireless charging receiving end and the wireless charging transmitting end.

Analysis of the existing technologies indicates that if the electric curtain is charged by using the wireless charging manner, the operation is more convenient and excessive use of a charging wire may also be avoided, but the charging efficiency is relatively low, requiring a long waiting time to fully charge, which may also bring inconvenience to the user. If the above wired charging is used, firstly, the relatively long charging wire of the electric curtain affects the aesthetics, while insufficient length of the charging wire may limit the choice of a charging position, resulting in inconvenient charging; and secondly, when charging, the electric curtain needs to be rolled up, so that the plug is matched with the socket, and the charging may affect the use of the electric curtain, that is, charging and opening and closing of the electric curtain are not independent of each other.

### SUMMARY

In view of the shortcomings of the related art, the present application provides an electric curtain.

The present application provides an electric curtain, including a guide rail, a telescopic rod, and a power supply. A telescopic end of the telescopic rod is provided with a connecting butt-joint piece, the connecting butt-joint piece is provided with a power output end, the power output end is electrically connected to the power supply, and the connecting butt-joint piece is provided with a support piece. The guide rail is provided with a connecting butt-joint part and a power storage apparatus, the connecting butt-joint part is provided with a power input end, the power input end is connected to the power storage apparatus, the connecting butt-joint part is detachably connected to the connecting butt-joint piece, the connecting butt-joint part is configured to butt the power input end with the power output end, the power input end is configured to receive power input by the power output end and charge the power storage apparatus, the connecting butt-joint part is further provided with a support part, and the support part is matched with the support piece to support the telescopic rod on the guide rail.

Preferably, the connecting butt-joint piece is respectively detachably connected to the connecting butt-joint part in one of a clamped connection manner, a threaded connection manner, a mortise and tenon connection manner, or an inserted connection manner.

Preferably, the connecting butt-joint piece is a clamping piece, one end of the clamping piece is connected to the telescopic end of the telescopic rod, a free end of the clamping piece is provided with a butt joint, and the power output end is arranged at the butt joint. The connecting butt-joint part is a clamping part connected to an outer wall of the guide rail, the clamping part protrudes out of the outer wall of the guide rail, a butt-joint groove is formed in the clamping part, the power input end corresponds to the position of the butt-joint groove, the butt joint is detachably connected to the butt-joint groove, and when the butt joint is clamped and fixed in the butt-joint groove, the power input end is electrically connected to the power output end.

Preferably, one end, away from the butt joint, of the clamping piece is provided with an arc-shaped limiting support groove, one end, away from the power input end, of the butt-joint groove is provided with an arc-shaped limiting support protruding block, and the limiting support protruding block is matched with the limiting support groove, and is configured to limit the butt joint to move towards one side of the limiting support protruding block.

Or, one end, away from the butt joint, of the clamping piece is provided with the arc-shaped limiting protruding block, one end, away from the power input end, of the butt-joint groove is provided with the arc-shaped limiting support groove, and the limiting support protruding block is matched with the limiting support groove, and is configured to limit the butt joint to move towards one side of the limiting support groove.

Preferably, the clamping piece and the butt joint are arranged at an angle, the clamping part is located on a side surface of the guide rail, the butt-joint groove is arranged upward, an upper end of the clamping part is further provided with a placement opening, the placement opening gradually narrows in a placement direction, and the width of a placement end of the placement opening is greater than the width of the butt joint. The power output end and the power input end are magnetic connectors with opposite magnetism or the clamping part is connected to the clamping piece through an elastic buckle. Or.

The clamping piece and the butt joint are coaxially arranged, the clamping part is located on a bottom surface of the guide rail, the butt-joint groove is arranged toward an inner side surface of the guide rail, the placement opening gradually narrows in the placement direction, the width of the placement end of the placement opening is greater than the width of the butt joint, and the clamping part is connected to the clamping piece through the elastic buckle.

Preferably, the connecting butt-joint part is a threaded connection part, the threaded connection part is an inner threaded port formed in the bottom of the guide rail, the power input end is arranged on a top wall of the threaded connection part, the connecting butt-joint piece is a threaded joint, the threaded joint is arranged at an upper end of the telescopic rod, the threaded joint and the telescopic rod are coaxially arranged, and the power output end is arranged at an upper end of the threaded joint.

Preferably, the connecting butt-joint part is a mortise and tenon piece, the mortise and tenon piece is arranged at an upper end of the telescopic rod, the power output end is arranged on the mortise and tenon piece, the connecting butt-joint part is a mortise and tenon part, the mortise and tenon part is arranged on an outer wall of the guide rail, the power input end is arranged on the mortise and tenon part, the mortise and tenon piece and the mortise and tenon part are interlocked and matched with each other, and the power output end and the power input end are respectively arranged on end surfaces, which are interlocked and matched with each other, of the mortise and tenon piece and the mortise and tenon part.

Preferably, the mortise and tenon pieces are a plurality of interlocking protruding blocks arranged on the end surfaces, which are interlocked and matched with each other, the mortise and tenon parts are a plurality of interlocking grooves formed in the end surfaces, which are interlocked and matched with each other, the interlocking protruding blocks and the interlocking grooves extend in an up-down direction, each interlocking groove is provided with a support bottom surface, and the support bottom surface is configured to support the mortise and tenon piece.

Preferably, the telescopic rod further includes a plurality of telescopic sleeves. The plurality of telescopic sleeves are telescopically sleeved in sequence, and the power output end is arranged on the uppermost telescopic sleeve. The power supply is a power supply battery, the power supply battery is arranged in the telescopic sleeve, and the power supply battery is electrically connected to the power output end. The guide rail is provided with a motor, the motor is electrically connected to the power storage apparatus, a controller is further arranged in the telescopic sleeve, and the controller is connected to the motor through a signal.

### BRIEF DESCRIPTION OF THE DRAWINGS

The above and other objects, features and advantages of the present application will become more apparent from the detailed description of the preferred embodiments of the present application shown in the accompanying drawings. The same reference signs in all the accompanying drawings represent the same parts, and the accompanying drawings are not intended to be drawn to scale, emphasis instead being placed upon illustrating the subject matter.

FIG. 1 is a schematic structural diagram of a curtain charging apparatus in a related art.

FIG. 2 is a schematic structural diagram of a curtain charging apparatus and an electric curtain provided by an embodiment.

FIG. 3 is a schematic structural diagram in which a connecting butt-joint part is matched with a connecting butt-joint piece in FIG. 2.

FIG. 4 is another schematic structural diagram of FIG. 3.

FIG. 5 is a section view of FIG. 4.

FIG. 6 is a schematic structural diagram in which a connecting butt-joint part is matched with a connecting butt-joint piece provided by another embodiment.

FIG. 7 is a schematic structural diagram of FIG. 6 from another perspective.

FIG. 8 is a schematic structural diagram in which a connecting butt-joint part is in threaded connection with a connecting butt-joint piece provided by an embodiment.

FIG. 9 is a schematic structural diagram in which a connecting butt-joint part is in mortise and tenon connection with a connecting butt-joint piece provided by an embodiment.

FIG. 10 is a schematic structural diagram of a mortise and tenon part in FIG. 9.

FIG. 11 is a schematic structural diagram of an inside of a telescopic rod.

### DETAILED DESCRIPTION OF THE EMBODIMENTS

In order to facilitate the understanding of the present application, the present application will be described more fully below with reference to the relevant drawings.

It is to be noted that when an element is considered to be “connected” to another element, it may be directly connected to and combined with another element or there may also be a centered element at the same time. The terms “mount”, “one end”, “the other end”, and similar expressions used herein are for illustrative purposes only.

Unless otherwise defined, all technical and scientific terms used herein have the same meaning as commonly understood by those skilled in the art of the present application. The terms used in the specification are only for the purpose of describing the specific embodiments and are not intended to limit the present application. The term “and/or” used herein includes any and all of combinations of one or more of the associated listed items.

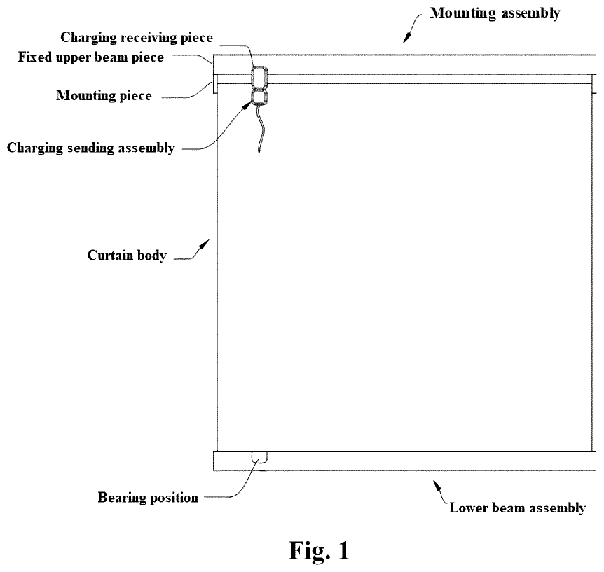

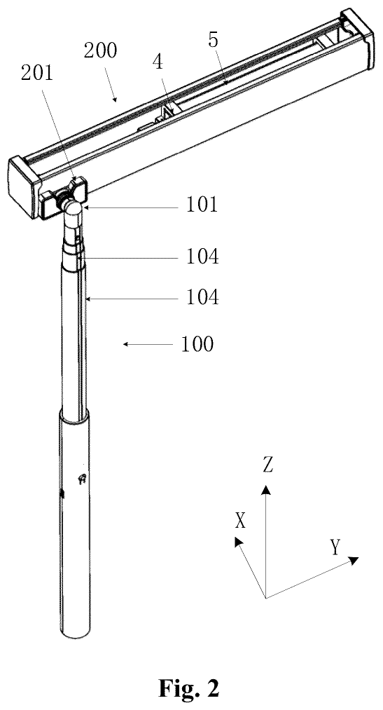

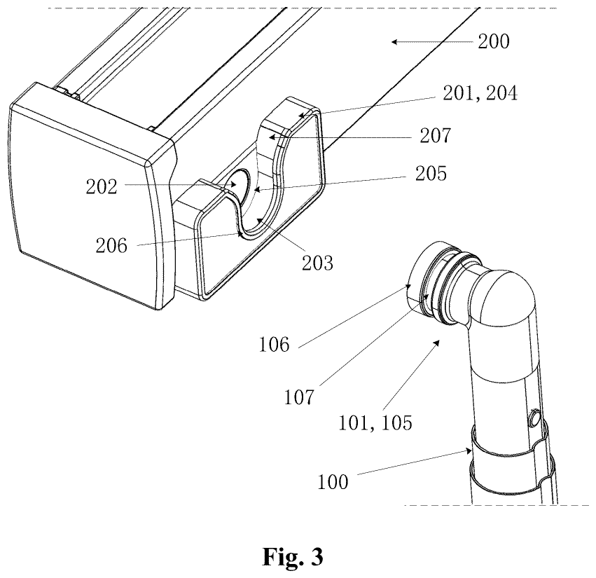

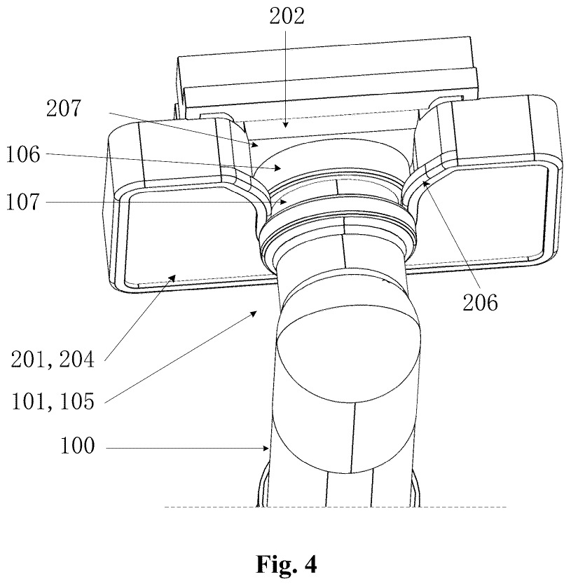

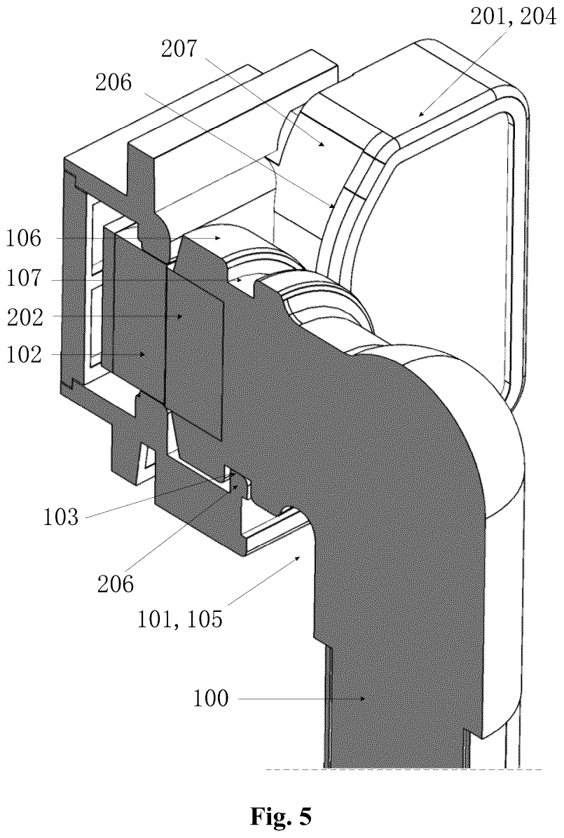

Referring to FIG. 1 to FIG. 11, another aspect of the present application provides an electric curtain. The electric curtain includes a guide rail 200, a telescopic rod 100, and a power supply 3. A telescopic end of the telescopic rod 100 is provided with a connecting butt-joint piece 101, the connecting butt-joint piece 101 is provided with a power output end 102, the power output end 102 is electrically connected to the power supply 3, the connecting butt-joint piece 101 is provided with a support piece 103, and the support piece 103 supports the telescopic rod 100 on the guide rail 200. The guide rail 200 is provided with a connecting butt-joint part 201 and a power storage apparatus 5, the connecting butt-joint part 201 is provided with a power input end 202, the connecting butt-joint part 201 is detachably connected to the connecting butt-joint piece 101, the connecting butt-joint part 201 is configured to butt the power input end 202 with the power output end 102, the power input end 202 is configured to receive power input by the power output end 102 and charge the power storage apparatus 5, the connecting butt-joint part 201 is further provided with a support part 203, and the support part 203 is matched with the support piece 103 to support the telescopic rod 100 on the guide rail 200.

Referring to FIG. 1 to FIG. 10, when in use, the telescopic rod 100 is first stretched to the appropriate length, and then the connecting butt-joint part 201 and the connecting butt-joint piece 101 are aligned and mounted together, so that the power input end 202 is butted with the power output end 102, and the power input end 202 is configured to receive power input by the power output end 102, that is, an electric apparatus and the power storage apparatus 5 in the guide rail 200 may be charged from the telescopic rod 100, and the support part 203 supports the telescopic rod 100 on the guide rail 200 through the support piece 103. At this time, the support part 203 and the support piece 103 are equivalent to a load-bearing structure, and the entire telescopic rod 100 is erected and fixed on the guide rail 200, so that the telescopic rod 100 may be provided with a heavier power supply 3, for example, a power supply battery 301, and the telescopic rod 100 is prevented from shaking in the charging process to be separated from the connecting butt-joint part 201.

Referring to FIG. 1 to FIG. 10, in a preferred embodiment, the connecting butt-joint part 201 is one of a clamping part 204, a threaded connection part 208, a mortise and tenon part 209, or an insertion piece part 213. The connecting butt-joint piece 101 corresponds to one of a clamping piece 105, a threaded connector 108, a tenon and mortise piece 109, or an insertion piece head 112 in sequence, and the connecting butt-joint piece 101 is respectively detachably connected to the connecting butt-joint part 201 in one of a clamped connection manner, a threaded connection manner, a mortise and tenon connection manner, or an inserted connection manner. The inserted connection manner may be used: an upper end of the telescopic rod 100 is provided with the insertion piece head 112, the power output end 102 is arranged in the insertion piece head 112, the guide rail 200 is provided with an insertion hole matched therewith, the power input end 202 is arranged in the insertion hole, when the insertion piece head 112 is inserted into the insertion hole, the power input end 202 is correspondingly connected to the power output end 102, so that charging may be performed, and the insertion piece head 112 is supported and fixed by an inner wall of the insertion hole, so as to support and fix the entire telescopic rod 100. Other clamped connection, threaded connection, and mortise and tenon connection manners may be referred to the following embodiments. Compared with the existing wireless charging manner of charging the electric curtain, the present application has relatively high charging efficiency, a relatively short full charging time, and does not bring inconvenience to a user. Compared with the existing manner of using a charging cable, a charging wire does not need to be erected, and charging is more convenient; and secondly, the curtain may be used independently when a curtain power supply apparatus charges an electrical appliance in the guide rail, which improves the convenience of using the electric curtain.

Referring to FIG. 1 to FIG. 7, in a preferred embodiment, FIG. 1 to FIG. 5 and FIG. 6 to FIG. 7 respectively show two clamped connection manners. The connecting butt-joint piece 101 is a clamping piece 105, one end of the clamping piece 105 is connected to the telescopic end of the telescopic rod 100, a free end of the clamping piece 105 is provided with a butt joint 106, the free end refers to an end away from a connection between the clamping piece 105 and the telescopic rod 100, and may be freely hung in a butt-joint groove 205 or removed from the butt-joint groove 205, the power output end 102 is arranged at the butt joint 106, and one end, away from the butt joint 106, of the clamping piece 105 is further provided with a limiting support groove 107. The connecting butt-joint part 201 is a clamping part 204 connected to an outer wall of the guide rail, the clamping part 204 protrudes out of the outer wall of the guide rail, the butt-joint groove 205 is formed in the clamping part 204, the butt-joint groove 205 is matched with the butt joint 106, the power input end 202 corresponds to the position of the butt-joint groove 205, the butt joint 106 is detachably connected to the butt-joint groove 205, and when the butt joint 106 is clamped and fixed in the butt-joint groove 205, the power input end 102 is electrically connected to the power output end 202. Further, one end, away from the butt joint 106, of the clamping piece 103 is provided with an arc-shaped limiting support groove 107, one end, away from the power input end 202, of the butt-joint groove 205 is further provided with a limiting support protruding block 206, the limiting support protruding block 206 is matched with the limiting support groove 107, and is configured to limit the butt joint 106 to move towards one side of the limiting support protruding block 206, and the limiting support protruding block 206 and the limiting support groove 107 further support the telescopic rod 100 in the support part 203. Of course, in other embodiments, one end, away from the butt joint, of the clamping piece 105 is provided with an annular limiting support protruding block, one end, away from the power input end, of the butt-joint groove 205 is provided with an arc-shaped limiting support groove, and the limiting support protruding block is matched with the limiting support groove, and is configured to limit the butt joint to move towards one side of the limiting support groove. Through the clamped connection manner, the telescopic rod 100 and the guide rail 200 are conveniently dismounted and mounted, and the convenience of a charging operation is improved.

Referring to FIG. 1 to FIG. 5, in a preferred embodiment, a preferred clamped connection manner is shown. The clamping piece 105 and the butt joint 106 are arranged at an angle, such as 50°, 70° or 120°, preferably 90°, the clamping part 204 is located on a side surface of the guide rail 200, such as a front side surface, a left side surface, and a rear side surface, the butt-joint groove 205 is arranged upward, an upper end of the clamping part 204 is further provided with a placement opening 207, the placement opening 207 gradually narrows in a placement direction, and the width of the placement opening 207 is greater than that of the butt joint 106. The width referred to herein is a left-right direction Y, which facilitates sliding of the butt joint 106 into the butt-joint groove 205. The power output end 102 and the power input end 202 are magnetic connectors 111 with opposite magnetism, the magnetic connectors 111 use the related art, and are internally provided with connection terminals for connection and electrification, and the power output end 102 and the power input end 202 have opposite magnetism, so that two magnetic attraction forces may be generated to ensure a tight and stable connection, thereby ensuring the electrical connection between the power output end 102 and the power input end 202. If magnetic attraction is used, the depth of the butt-joint groove 205 in a front-back direction X is greater than the thickness of the butt joint 106 in the front-back direction X, so that the butt joint 106 is conveniently placed into the butt-joint groove 205, and at this time, the butt joint and fixation of an electrode are completed through magnetic attraction.

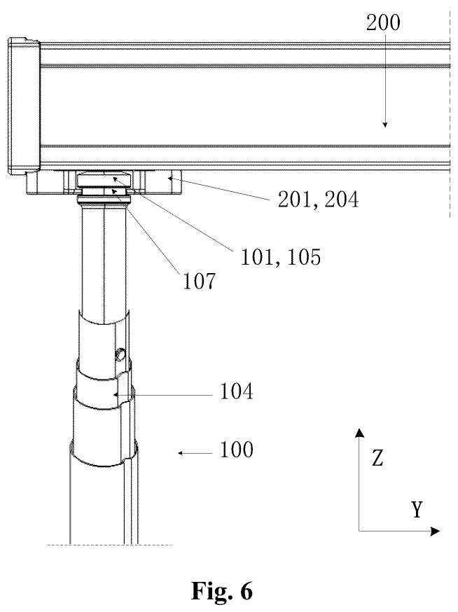

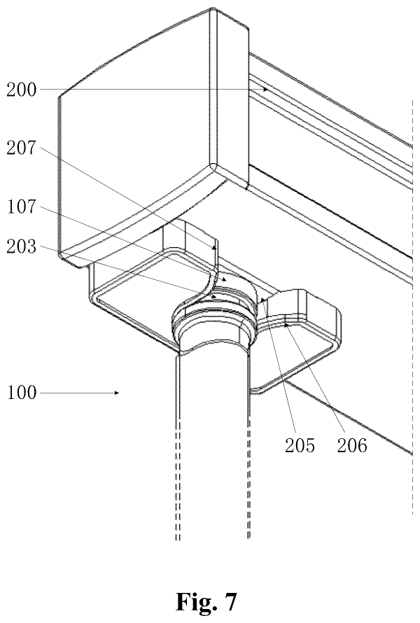

Referring to FIG. 6 to FIG. 7, in a preferred embodiment, another preferred clamped connection manner is shown. The clamping piece 105 and the butt joint 106 are coaxially arranged, the clamping part 204 is located on a bottom surface of the guide rail 200, the butt-joint groove 205 is arranged toward an inner side surface of the guide rail 200, the inner side surface refers to a side surface facing away from a window and toward an inner surface of a room, the placement opening 207 gradually narrows in the placement direction, the width of the placement opening 207 is greater than the width of the butt joint 106, and the clamping part 204 is connected to the clamping piece 105 through an elastic buckle. The butt-joint groove 205 has elasticity and the depth in an up-down direction Z is less than or equal to the thickness of the butt joint 106, the depth of the placement opening 207 is greater than the thickness of the butt joint 106, and the butt joint 106 is clamped into the butt-joint groove 205 with elasticity from the placement opening 207 to complete the butt-joint and mounting of the butt joint 106 and the butt-joint groove 205. Of course, the above clamped connection manner may also connect the clamping part 204 to the clamping piece 105 through the elastic buckle to replace a magnetic connection manner.

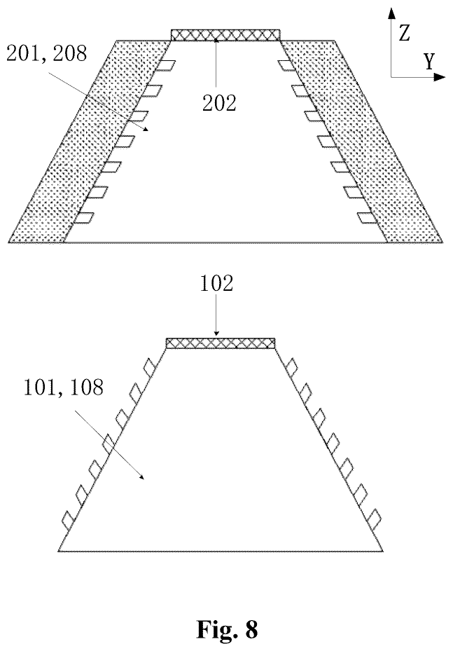

Referring to FIG. 8, in a preferred embodiment, the connecting butt-joint part 201 is a threaded connection part 208, the threaded connection part 208 is an inner threaded port formed in the bottom of the guide rail 200, the power input end 202 is arranged on a top wall of the threaded connection part 208, the connecting butt-joint piece 101 is a threaded joint 108, the threaded joint 108 is arranged on an upper end of the telescopic rod 100, the threaded joint 108 and the telescopic rod 100 are coaxially arranged, and the power output end 102 is arranged at an upper end of the threaded joint 108. When in use, the threaded joint 108 is aligned with the threaded connection part 208, then the telescopic rod 100 is rotated in one direction, and the threaded joint 108 is matched in the threaded connection part 208 through a screw thread, and at this time, the power input end 202 is butted with the power output end 102 to achieve the electrical connection, and since the threaded connection is used, the telescopic rod 100 may be supported and fixed in the threaded connection part 208. When charging is completed, the telescopic rod 100 is rotated in another direction, and the threaded joint 108 exits the threaded connection part 208 to achieve separation.

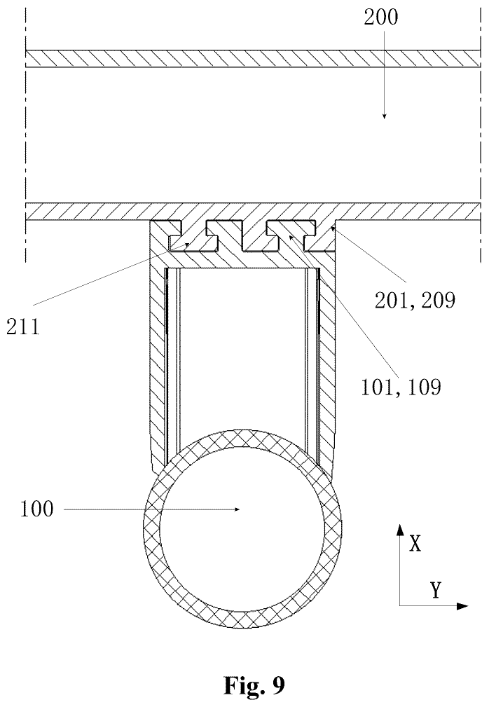

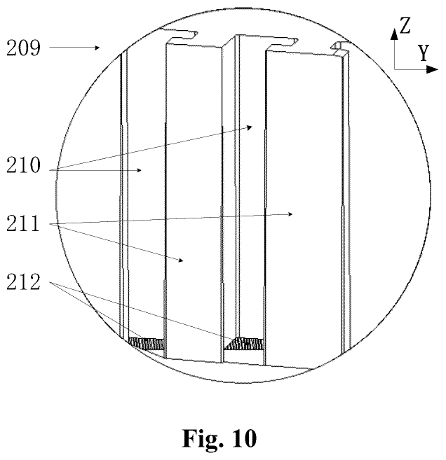

Referring to FIG. 9 to FIG. 10, in a preferred embodiment, the connecting butt-joint piece 101 is a mortise and tenon piece 109, the mortise and tenon piece 109 is arranged at an upper end of the telescopic rod 100, the power output end 102 is arranged on the mortise and tenon piece 109, the connecting butt-joint part 201 is a mortise and tenon part 209, the mortise and tenon part 209 is arranged on an outer wall of the guide rail 200, the power input end 202 is arranged on the mortise and tenon part 209, the mortise and tenon piece 109 and the mortise and tenon part 209 are interlocked and matched with each other, and the power output end 102 and the power input end 202 are respectively arranged on end surfaces, which are interlocked and matched with each other, of the mortise and tenon piece 109 and the mortise and tenon part 209. When the mortise and tenon parts 209 are arranged on the front and rear side surfaces and the left and right side surfaces of the guide rail 200, the mortise and tenon part 109 and the telescopic rod 100 are arranged at an angle, for example, 50°, 70°, or 120°, preferably 90°, and when the mortise and tenon part 209 is arranged on the bottom surface of the guide rail 200, the mortise and tenon piece 109 and the telescopic rod 100 are coaxially arranged.

Referring to FIG. 9 to FIG. 10, in a preferred embodiment, the mortise and tenon pieces 109 are a plurality of interlocking protruding blocks 211 arranged on the end surfaces, which are interlocked and matched with each other, the mortise and tenon parts 209 are a plurality of interlocking grooves 210 formed in the end surfaces, which are interlocked and matched with each other, so as to achieve quick mounting and dismounting, the interlocking protruding blocks 211 and the interlocking grooves 210 extend in the up-down direction Z, each interlocking groove 210 is provided with a support bottom surface 212, and the support bottom surface 212 is configured to support the mortise and tenon piece 109. The power output end 102 and the power input end 202 are conveniently arranged at positions corresponding to the protruding block and the groove to achieve the electrical connection.

Referring to FIG. 9 to FIG. 10, when in use, the mortise and tenon piece 109 is inserted into the mortise and tenon part 209 from the top, at this time, the interlocking protruding block 211 of the mortise and tenon piece 109 is clamped into the interlocking groove 210 of the mortise and tenon part 209, meanwhile, the interlocking protruding block 211 of the mortise and tenon part 209 is clamped into the mortise and tenon piece 109 of the interlocking groove 210 to achieve the interlocking connection between the mortise and tenon piece 109 and the mortise and tenon part 209, at this time, the mortise and tenon piece 109 and the mortise and tenon part 209 are detachably connected and mounted, and the telescopic rod 100 may also be supported.

Referring to FIG. 1 to FIG. 11, in a preferred embodiment, the telescopic rod 100 further includes a plurality of telescopic sleeves 104. The plurality of telescopic sleeves 104 are telescopically sleeved in sequence, and the power output end 102 is arranged on the uppermost telescopic sleeve 104. The power supply 3 is a power supply battery 301, the power supply battery 301 is arranged in the telescopic sleeve 104, and the power supply battery 301 is electrically connected to the power output end 202. The arrangement of the power supply battery 301 avoids the use of an electric wire and a socket, and is matched with the telescopic function of the telescopic rod 100, so that the curtain power supply apparatus may be applied to different use scenarios, and is not limited by the length of the electric wire and the charging position. The guide rail is provided with a motor 4, the motor 4 is electrically connected to the power storage apparatus 5, a controller 6 is further arranged in the telescopic sleeve, and the controller 6 is connected to the motor 4 through a signal, such as a wireless signal. When the curtain power supply apparatus charges the electric curtain, the power supply battery 301 is respectively electrically connected to the controller 6, the motor 4, and the power storage apparatus 5, and the controller 6 may control the motor 4 to perform an action, so that the electric curtain may still work normally in the charging process.

The power storage apparatus 5 and the motor 4 are arranged in the guide rail 200, the power storage apparatus 5 is a power supply battery, the power supply battery is respectively electrically connected to the motor 4 and the power input end 202, and the power supply battery 301 charges the battery. The controller 6 is further arranged in the telescopic sleeve 104, and the controller 6 is connected to the motor 4 through a signal.

In the present application, unless otherwise specified and defined, the first feature “on” or “under” the second feature may be direct contact of the first and second features, or the first and second features may be in indirect contact through an intermediate medium. Moreover, the first feature “over”, “above” and “on” the second feature may mean that the first feature is directly above or obliquely above the second feature, or it only means that the level of the first feature is higher than the second feature. The first feature “neath”, “below” and “under” the second feature may mean that the first feature is directly below or obliquely below the second feature, or it only means that the level of the first feature is smaller than the second feature.

In the description of the present specification, descriptions of the reference terms “preferred embodiment”, “another embodiment”, “other embodiments”, “specific example”, etc., mean that specific features, structures, materials, or characteristics described in combination with the embodiment or the example are included in at least one embodiment or example of the present application. In this specification, schematic representations of the above terms do not necessarily refer to the same embodiment or example. Furthermore, the specific features, structures, materials, or characteristics described may be combined in any suitable manner in any one or more embodiments or examples. In addition, those skilled in the art may combine different embodiments or examples and features of different embodiments or examples described in the specification without conflicts.

Although the embodiments of the present application have been shown and described above, it may be understood that the foregoing embodiments are exemplary and cannot be understood as a limitation on the present application, and those of ordinary skill in the art may make changes, modifications, replacements, and variations to the foregoing embodiments within the scope of the present application.

1. An electric curtain, comprising a guide rail, a telescopic rod, and a power supply, wherein a telescopic end of the telescopic rod is provided with a connecting butt-joint piece, the connecting butt-joint piece is provided with a power output end, the power output end is electrically connected to the power supply, and the connecting butt-joint piece is provided with a support piece;
the guide rail is provided with a connecting butt-joint part and a power storage apparatus, the connecting butt-joint part is provided with a power input end, the power input end is connected to the power storage apparatus, the connecting butt-joint part is detachably connected to the connecting butt-joint piece, the connecting butt-joint part is configured to butt the power input end with the power output end, the power input end is configured to receive power input by the power output end and charge the power storage apparatus, the connecting butt-joint part is further provided with a support part, and the support part is matched with the support piece to support the telescopic rod on the guide rail.

2. The electric curtain as claimed in claim 1, wherein the connecting butt-joint piece is detachably connected to the connecting butt-joint part in one of a clamped connection manner, a threaded connection manner, a mortise and tenon connection manner, or an inserted connection manner.

3. The electric curtain as claimed in claim 1, wherein the connecting butt-joint piece is a clamping piece, one end of the clamping piece is connected to the telescopic end of the telescopic rod, a free end of the clamping piece is provided with a butt joint, and the power output end is arranged at the butt joint; and
the connecting butt-joint part is a clamping part connected to an outer wall of the guide rail, the clamping part protrudes out of the outer wall of the guide rail, a butt-joint groove is formed in the clamping part, the power input end corresponds to the position of the butt-joint groove, the butt joint is detachably connected to the butt-joint groove, and when the butt joint is clamped and fixed in the butt-joint groove, the power input end is electrically connected to the power output end.

4. The electric curtain as claimed in claim 3, wherein one end, away from the butt joint, of the clamping piece is provided with an arc-shaped limiting support groove, one end, away from the power input end, of the butt-joint groove is provided with an arc-shaped limiting support protruding block, and the limiting support protruding block is matched with the limiting support groove, and is configured to limit the butt joint to move towards one side of the limiting support protruding block; or
one end, away from the butt joint, of the clamping piece is provided with the arc-shaped limiting protruding block, one end, away from the power input end, of the butt-joint groove is provided with the arc-shaped limiting support groove, and the limiting support protruding block is matched with the limiting support groove, and is configured to limit the butt joint to move towards one side of the limiting support groove.

5. The electric curtain as claimed in claim 4, wherein the clamping piece and the butt joint are arranged at an angle, the clamping part is located on a side surface of the guide rail, the butt-joint groove is arranged upward, an upper end of the clamping part is further provided with a placement opening, the placement opening gradually narrows in a placement direction, and the width of a placement end of the placement opening is greater than the width of the butt joint; the power output end and the power input end are magnetic connectors with opposite magnetism; or the clamping part is connected to the clamping piece through an elastic buckle; or
the clamping piece and the butt joint are coaxially arranged, the clamping part is located on a bottom surface of the guide rail, the butt-joint groove is arranged toward an inner side surface of the guide rail, the placement opening gradually narrows in the placement direction, the width of the placement end of the placement opening is greater than the width of the butt joint, and the clamping part is connected to the clamping piece through the elastic buckle.

6. The electric curtain as claimed in claim 2, wherein the connecting butt-joint part is a threaded connection part, the threaded connection part is an inner threaded port formed in the bottom of the guide rail, the power input end is arranged on a top wall of the threaded connection part, the connecting butt-joint part is a threaded joint, the threaded joint is arranged at an upper end of the telescopic rod, the threaded joint and the telescopic rod are coaxially arranged, and the power output end is arranged at an upper end of the threaded joint.

7. The electric curtain as claimed in claim 2, wherein the connecting butt-joint piece is a mortise and tenon piece, the mortise and tenon piece is arranged at an upper end of the telescopic rod, the power output end is arranged on the mortise and tenon piece, the connecting butt-joint part is a mortise and tenon part, the mortise and tenon part is arranged on an outer wall of the guide rail, the power input end is arranged on the mortise and tenon part, the mortise and tenon piece and the mortise and tenon part are interlocked and matched with each other, and the power output end and the power input end are respectively arranged on end surfaces, which are interlocked and matched with each other, of the mortise and tenon piece and the mortise and tenon part.

8. The electric curtain as claimed in claim 7, wherein the mortise and tenon pieces are a plurality of interlocking protruding blocks arranged on the end surfaces, which are interlocked and matched with each other, the mortise and tenon parts are a plurality of interlocking grooves formed in the end surfaces, which are interlocked and matched with each other, the interlocking protruding blocks and the interlocking grooves extend in an up-down direction, each interlocking groove is provided with a support bottom surface, and the support bottom surface is configured to support the mortise and tenon piece.

9. The electric curtain as claimed in claim 1, wherein the telescopic rod further comprises a plurality of telescopic sleeves, wherein the plurality of telescopic sleeves are telescopically sleeved in sequence, and the power output end is arranged on the uppermost telescopic sleeve; the power supply is a power supply battery, the power supply battery is arranged in the telescopic sleeve, and the power supply battery is electrically connected to the power output end; and the guide rail is provided with a motor, the motor is electrically connected to the power storage apparatus, a controller is further arranged in the telescopic sleeve, and the controller is connected to the motor through a signal.
